(19) United States
(12) Patent Application Publication
(10) Pub. No.: US 2023/0357581 A1
(43) Pub. Date: Nov. 9, 2023

(54) REINFORCING THERMAL RADIATION COATING AND APPLICATION, AND RADIANT HEAT EXCHANGE APPARATUS USING SAME

(71) Applicant: Jiguang YAN, Zhuhai (CN)

(72) Inventor: Jiguang YAN, Zhuhai (CN)

(21) Appl. No.: 18/246,814

(22) PCT Filed: Sep. 29, 2020
(86) PCT No.: PCT/CN2020/118616

§ 371 Date: Mar. 27, 2023

(30) Foreign Application Priority Data
Sep. 27, 2020 (CN) 202011030695.X

(51) Int. Cl. C09D 5/32; C09D 7/61; C09D 7/20; C09D 125/14; F28F 21/08

(52) U.S. Cl. CPC C09D 5/32; C09D 7/61; C09D 7/20; C09D 125/14; F28F 21/089; C08K 2003/023

(57) ABSTRACT

Disclosed area reinforcing thermal radiation coating and application and a radiant heat exchange apparatus using the same. The reinforcing thermal radiation coating comprises a reinforcing material component, a black material component and a binder. The reinforcing material component is silicon and/or boron. The coating can be applied to a surface of a metal material for use as a coating film. A radiant heat exchange apparatus comprises a first metal radiant plate and a heat exchange core plate formed by a second metal radiant plate and a heat transfer core plate. The coating can form a coating film on the surface of a metal material, which can greatly improve the absorptivity and emissivity of the surface of the metal material. The apparatus can be used for cooling and heating and can work for cooling in a hot and humid environment without dew condensation and also has a high cooling capacity.

### BACKGROUND OF THE PRESENT INVENTION

The invention relates to the field of radiant heat exchange, and in particular to a reinforcing thermal radiation coating and an application and radiant heat exchange apparatus using the same.

### DESCRIPTION OF RELATED ARTS

There are generally following types of metal radiant heat exchange plates in the prior:

In a mode where a heat exchange copper tube and a metal radiant heat transfer plate are in direct contact, the heat exchange copper tube and the metal radiant plate are connected by heat conduction. This mode is mostly used in air-conditioning occasions. In northern Europe, 12° C. cold water is applied to the heat exchange copper tube, and the surface temperature of the metal radiant plate is 20° C., but the surface of the metal radiant plate has a cold line of 14° C., so it is feasible in northern Europe most of the time. However, in a relatively hot and humid environment, the temperature of 14° C. is already lower than the dew point temperature, and dew condensation will occur on the metal radiant plate. In order to avoid dew condensation, 16° C. cold water is used. The temperature of the contact part between the surface of the metal radiant plate and the heat exchange copper tube is only 18° C., and the temperature of the surface of the metal radiant plate without contact rises to 24° C. The cooling capacity of the metal radiant plate is very low. When used in air conditioners in areas with large heat and humidity loads, this high-temperature-water metal radiant plate can only be used as a supplement to ordinary air conditioners.

For other improved metal radiant plate structures, in order to solve the problem about the cold uniformity of the surface on the metal radiant plate, TROX presses the heat exchange copper tube into a u groove-shaped metal base, and then the metal base is bonded to the metal plate with a heat-conducting adhesive, However, in the heating condition, after being baked, the thermal conductive adhesive loses its viscosity and cannot conduct heat; so the Product Manual of TROX states “not for the purpose of supply heat”.

There are also products in which a heat exchange copper tube is buried in a graphite material, and then the graphite block is fixed on the metal plate with a thermal conductive adhesive. However, when all metal radiant plate products are working in a cooling condition, due to the problem of dew condensation on the surface of the plate, the temperature of a heat exchange refrigerant cannot be lower than the dew point temperature of air.

### SUMMARY OF THE PRESENT INVENTION

In order to solve the above-mentioned technical problems, the invention provides an enhancing thermal radiation coating which has an extraordinary effect of absorbing and emitting thermal radiation energy in an infrared band. The coating, after being applied to the surface of a metal material, can greatly improve the absorptivity and emissivity of the surface of the metal material. Further provided is a radiant heat exchange apparatus, in which a reinforcing thermal radiation coating is applied between a first metal radiant plate and a heat exchange core plate to form a reinforcing thermal radiation coating film, which greatly improves the heat exchange efficiency between the first metal radiant plate and the heat exchange core plate. The radiant heat exchange apparatus can be used for both cooling and heating. The radiant heat exchange apparatus can work for cooling in a hot and humid environment without causing dew condensation and also has a high cooling capacity.

A technical solution adopted in the invention to solve its technical problems is: a reinforcing thermal radiation coating, comprising, by mass: 4-6 parts of a reinforcing material component, 6-13 parts of a black material component, and 81-90 parts of a binder, wherein the reinforcing material component is silicon or boron or a mixture of silicon and boron in any proportion, the black material component is used to increase the blackness of the coating, and the binder component is used to provide adhesion to the coating.

The black material component is one of iron oxide black, carbon black and manganese dioxide or a mixture of several thereof in any proportion.

The binder comprises, by mass, 50-60 parts of a solvent and 20-40 parts of a binder component; the solvent is one of xylene, trimethylbenzene, tetramethylbenzene, 1,2-dichloroethane, and n-butyl acetate or a mixture of several thereof in any proportion; the binder component is a copolymer of styrene, n-butyl acrylate and isopropyl acrylate and a molar ratio of styrene to n-butyl acrylate to isopropyl acrylate is (4-6):(2-4):1.

Specifically, the reinforcing thermal radiation coating is prepared from, by mass, 2.5 parts of elemental silicon powder, 2.5 parts of elemental boron powder, 2 parts of carbon black, 2 parts of manganese dioxide, 6 parts of iron oxide black, 30 parts of a styrene/n-butyl acrylate/isopropyl acrylate copolymer, 37 parts of xylene, 12 parts of 1,2-dichloroethane, and 6 parts of n-butyl acetate, wherein the molar ratio of styrene to n-butyl acrylate to isopropyl acrylate is 5:3:1.

There is provided an application of a reinforcing thermal radiation coating, where the reinforcing thermal radiation coating is applied to a surface of a metal material to form a reinforcing thermal radiation coating film.

There is further provided a radiant heat exchange apparatus, comprising a first metal radiant plate, a second metal radiant plate, and a heat transfer channel, wherein the second metal radiant plate is in contact with the heat transfer channel and forms a heat exchange core plate together the heat transfer channel; the first metal radiant plate is provided with a first radiant heat exchange area on a side close to the heat exchange core plate, the heat exchange core plate corresponds to the first radiant heat exchange area of the first metal radiant plate and is placed in parallel to and spaced from the first radiant heat exchange area of the first metal radiant plate with an interval, the minimum interval between the heat exchange core plate and the first metal radiant plate is defined as 1-3 mm, and a reinforcing thermal radiation coating film is formed on a side surface of the heat exchange core plate close to the first metal radian plate and on a surface of the first radiant heat exchange area.

The interval is formed by an isolation net arranged between the heat exchange core plate and the first metal radiant plate, a skeleton of the isolation net is configured to provide isolation and support functions, mesh holes of the isolation net are configured to provide space for radiant heat exchange, and the isolation net has a thickness of 1-3 mm to ensure that the minimum interval between the heat exchange core plate and the first metal radian plate is within a range of 1 mm to 3 mm.

The isolation net has a thickness of 2 mm to ensure that the minimum interval between the heat exchange core plate and the first metal radian plate is 2 mm.

The heat transfer channel is configured as a heat transfer coil provided with a heat transfer medium therein; a first groove corresponding to the heat transfer coil is pressed on the second metal radiant plate, the heat transfer coil is placed in the first groove of the second metal radiant plate, the first groove of the second metal radiant plate is also correspondingly provided with a bead, the bead also has a second groove corresponding to the first groove, the first groove and the second groove jointly form an accommodating channel for the heat transfer coil, the bead is also configured to make an outer wall of the heat transfer coil closely adhere to an inner wall of the groove of the second metal radiant plate.

The radiant heat exchange apparatus further comprises a housing, wherein the housing and the first metal radiant plate form a closed cavity and the heat exchange core plate is arranged in the cavity; a thermal insulation body is arranged in the housing, and the thermal insulation body is bonded to the first metal radiant plate to form an insulating sealed cavity, which is used to prevent internal dew condensation caused by moisture entering an empty cavity between the heat exchange core plate and the first metal radiant plate and which is also used to isolate heat transfer between the housing and the heat exchange core plate; the housing is configured to reflect the energy of external thermal radiation through an outer surface thereof, and can protect the thermal insulation body from damage by an external force; two ends of the heat transfer coil respectively pass through the thermal insulation body and the housing and are exposed outside the radiant heat exchange apparatus; the housing is provided with a through hole at the position where the heat transfer coil runs out of the radiant heat exchange apparatus; a sealing ring fitted over the heat transfer coil is also arranged in the through hole.

The advantages of the invention: The enhancing thermal radiation coating of the invention has an extraordinary effect of absorbing and emitting thermal radiation energy in an infrared band. The coating, after being applied to the surface of a metal material, can greatly improve the absorptivity and emissivity of the surface of the metal material. The radiant heat exchange apparatus can be used for both cooling and heating. Especially, the apparatus can be used for cooling in a hot and humid environment without causing dew condensation, and has a high cooling capacity. The reinforcing thermal radiation coating is applied between the first metal radiant plate and the heat exchange core plate to form a reinforcing thermal radiation coating film, which greatly improves the heat exchange efficiency between the first metal radiant plate and the heat exchange core plate. The minimum interval which is 1-3 mm is set between the first metal radiant plate and the heat exchange core plate to form sub-near-field thermal radiation. In this way, on the one hand, it can avoid the situation where, if the distance between the two plates is too close, a more obvious cold-worm line will be formed during the cooling process, which is more likely to cause dew condensation on the surfaces of the plates. On the other hand, the sub-near-field radiation greatly improves the radiation efficiency of the first metal radiant plate and the heat exchange core plate at the heat transfer coil, and also can achieve more uniform thermal radiation of the two plates in cooperation with the reinforcing thermal radiation coating film, thereby improving the temperature uniformity of the outer surface (the side in contact with the environment to be conditioned in temperature). It can further avoid the obvious cold-temperature line during the cooling process. Since there is no influence of the cold-temperature line, a lower-temperature heat transfer medium can also be used for cooling without causing dew condensation. Through the design of the heat transfer coil wrapped with the bead and the second radiant metal plate, the maximum degree of close contact with the heat transfer coil can be achieved, thereby ensuring the heat exchange efficiency between the second radiant metal plate and the heat transfer coil. The design of the thermal insulation body can isolate the external moisture and heat, avoid the influence of the external environment on the radiation heat transfer between the first metal radiant plate and the heat exchange core plate, and avoid internal dew condensation between the first metal radiant plate and the heat exchange core plate. The design of the housing can protect the thermal insulation body from being damaged by external force and can realize further sealing. In addition, the outer surface of the housing can be designed as a mirror surface to reflect thermal radiation from the external environment.

### BRIEF DESCRIPTION OF THE DRAWINGS

FIG. 1 is a schematic diagram of a radiant heat exchange apparatus according to a first embodiment;

FIG. 2 is a schematic exploded diagram of the radiant heat exchange apparatus according to the first embodiment;

FIG. 3 is a schematic diagram of an internal structure of the radiant heat exchange apparatus according to a first embodiment; and

FIG. 4 is a schematic diagram of an assembly of a first metal radiant plate and a heat exchange core plate in the radiant heat exchange apparatus according to the first embodiment.

### DETAILED DESCRIPTION OF THE PREFERRED EMBODIMENT

In order to deepen the understanding of the invention, the invention will be described in further detail below in conjunction with the accompanying drawings and embodiments. The embodiments are only for the illustrative purpose and should not be construed as limiting the scope of the invention.

### First Embodiment

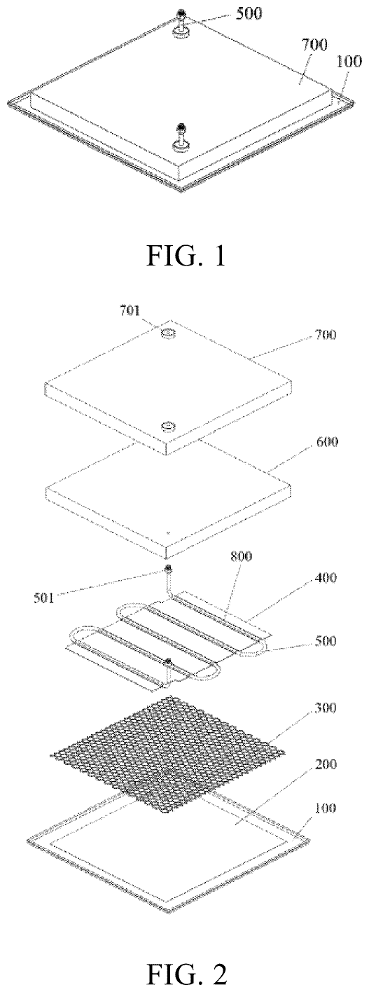

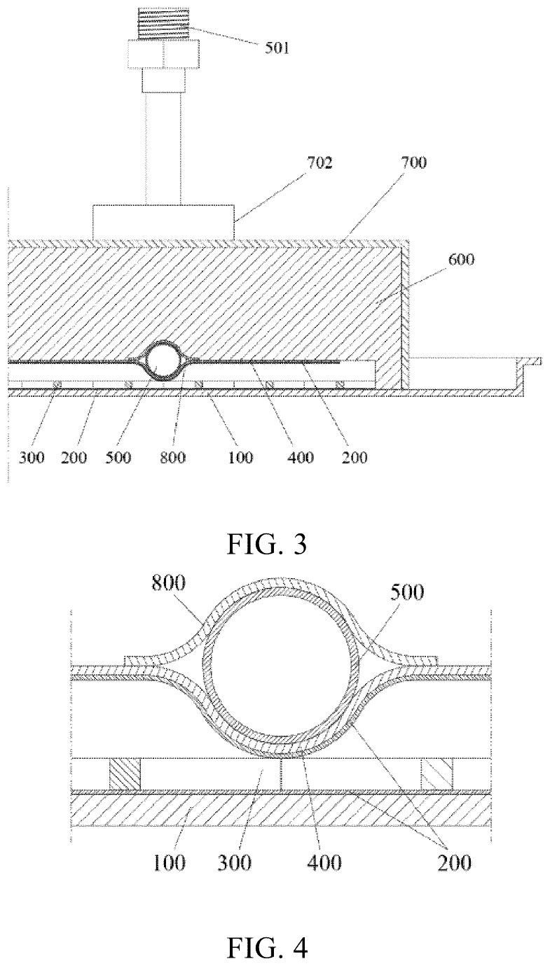

Referring to FIGS. 1-4, this embodiment provides a radiant heat exchange apparatus, comprising a first metal radiant plate 100, a second metal radiant plate 400, and a heat transfer channel 500, wherein the second metal radiant plate 400 is in contact with the heat transfer channel 500 and forms a heat exchange core plate together the heat transfer channel; the first metal radiant plate 100 is provided with a first radiant heat exchange area on a side close to the heat exchange core plate, the heat exchange core plate corresponds to the first radiant heat exchange area of the first metal radiant plate 100 and is placed in parallel to and spaced from the first radiant heat exchange area of the first metal radiant plate with an interval, the minimum interval between the heat exchange core plate and the first metal radiant plate is 2 mm, and a reinforcing thermal radiation coating film 200 is formed on a side surface of the heat exchange core plate close to the first metal radian plate 100 and on a surface of the first radiant heat exchange area.

In the radiant heat exchange apparatus of this embodiment, the interval is formed by an isolation net 300 arranged between the heat exchange core plate and the first metal radiant plate 100, a skeleton of the isolation net 300 is configured to provide isolation and support functions, mesh holes of the isolation net 300 are configured to provide space for radiant heat exchange, and the isolation net has a thickness of 2 mm to ensure that the minimum interval between the heat exchange core plate and the first metal radian plate is 2 mm.

In the radiant heat exchange apparatus of this embodiment, the heat transfer channel 500 is configured as a heat transfer coil provided with a heat transfer medium therein, a first groove corresponding to the heat transfer coil is pressed on the second metal radiant plate 400, the heat transfer coil is placed in the first groove of the second metal radiant plate 400, the first groove of the second metal radiant plate 400 is also correspondingly provided with a bead 800, the bead 800 also has a second groove corresponding to the first groove, the first groove and the second groove jointly form an accommodating channel for the heat transfer coil, and the bead 800 is also configured to make an outer wall of the heat transfer coil closely adhere to an inner wall of the groove of the second metal radiant plate 400. Radiant heat exchange is performed between the heat exchange core plate and the first radiation heat exchange area of the first metal radiant plate. Conduction heat exchange is performed between the second metal radiant plate and the heat transfer coil.

In this embodiment, the radiant heat exchange apparatus further comprises a housing 700. The housing 700 and the first metal radiant plate 100 form a closed cavity and the heat exchange core plate is arranged in the cavity. The housing 700 is configured to reflect the energy of external thermal radiation through the outer surface thereof, and is also configured to isolate the inside of the cavity from the outside. A thermal insulation body 600 is arranged between the inner side of the housing 700 and the heat exchange core plate to isolate the heat exchange core plate from the housing 700. The thermal insulation body 600 also seals the heat exchange core plate on the second metal radiant plate 400 to prevent moisture from entering a cavity between the heat exchange core plate and the first metal radiant plate. Two ends of the heat transfer coil respectively pass through the thermal insulation body 600 and the housing 700 and are exposed outside the radiant heat exchange apparatus. The housing 700 is provided with a through hole 702 at the position where the heat transfer coil 500 runs out of the radiant heat exchange apparatus. A sealing ring 701 fitted over the heat transfer coil 500 is also arranged in the through hole 702.

In the radiant heat exchange apparatus of this embodiment, the first metal radiant plate and the second metal radiant plate are preferably aluminum plates, which have the advantages of light weight, easy processing, and low cost. Certainly, other metal plates also can be used to process the first metal radiant plate and the second metal radiant plate.

In the radiant heat exchange apparatus of this embodiment, the heat transfer channel is generally configured as a copper tube, and can also be configured as a heat conduction tube made of other materials. The heat on the surface of the heat exchange core plate is taken away by the flow of the medium in the tube, and the heat transfer medium can be various cold/heat media, which is not specifically limited here.

In the radiant heat exchange apparatus of this embodiment, there is an interval between the second metal radiant plate 400 and the first metal radiant plate 100, and the minimum interval is defined as 1-3 mm, preferably 2 mm. This solution is obtained on the basis of the following facts. If two surfaces that generate infrared radiation are very close, strong thermal radiation will also occur, which is called near-field radiation. Specifically in the radiant heat exchange apparatus, when the distance between the second metal radiant plate and the first metal radiant plate is too close, a low-temperature line of the heat transfer coil during a cooling process will be projected onto the first metal radiant plate through near-field radiation, and a more obvious cold-temperature line is formed. In this case, the surface of the first metal radiant plate is prone to dew condensation at the corresponding position, and when the interval between the second metal radiant plate and the first metal radiant plate is defined as 1-3 mm, especially 2 mm, the thermal radiation heat exchange capacity of the second metal radiant plate and the first metal radiant plate is the best, and during the cooling process, the first metal radiant plate has no obvious low-temperature cold line (so-called sub-near-field interval), which can maximize the cooling or heating efficiency of the radiant heat exchange apparatus.

In the radiant heat exchange apparatus of this embodiment, in order to ensure that the interval between the heat exchange core plate and the first metal radiant plate 100 can reach a specific distance, an isolation net is sandwiched between the heat exchange core plate and the first metal radiant plate. The isolation net is a mesh structure made of a material with low thermal conductivity. The skeleton of the mesh structure is used to provide isolation and support functions, and the mesh holes are used to provide space for radiant heat exchange. For better results, to ensure support, the larger the mesh holes, the better the results are.

In the radiant heat exchange apparatus of this embodiment, the second metal radiant plate is in contact with the heat transfer channel in such a way that heat conduction can be realized. Certainly, a larger contact area can improve the efficiency of heat conduction. This embodiment provides a contact mode between the second metal radiant plate and the heat transfer channel, specifically the contact between the second metal radiant plate and the heat transfer coil. The heat transfer coil is an S-shaped coil, which has a plurality of straight parts arranged in parallel and bent parts connecting the straight parts. The second metal radiant plate is provided with first grooves corresponding to the straight parts. The straight parts of the heat transfer coil are placed in the first grooves of the second metal radiant plate. A bead is arranged on the upper side of the straight part and also provided with a second groove corresponding to the straight part. The beads work with the first grooves of the second metal radiant plate through the second grooves to wrap the outer sides of the straight parts. Usually, both the first grooves and the second grooves are approximately semicircular, and the two ends of the semicircle form a rounded transition with the plane of the second metal radiant plate or the bead, which is easy for processing. The beads and the first metal radiant panel can be fixed together by crimping, bonding, welding or other processing methods. By means of this design, the beads and the first metal radiant plate can be in close contact with the heat transfer coil, which can increase the heat conduction contact area with the heat transfer coil and can also reduce the heat conduction gap with the heat transfer coil, maximizing the heat conduction efficiency with the heat transfer coil. Furthermore, the overall heat transfer of the heat exchange core plate becomes more uniform, and the influence of the straight parts of the heat transfer coil on the uniformity of heat transfer is reduced, which solves the problem of the low-temperature line from the other hand. The temperature of the heat transfer medium in the heat transfer coil can be reduced further during the cooling process without causing dew condensation. Moreover, due to the uniformity of heat transfer, the temperature uniformity of the first metal radiant plate can be further improved, so that the entire first metal radiant plate can participate in the temperature conditioning of the environment, and the heat exchange capacity of the radiant heat exchange apparatus can be greatly improved.

In the radiant heat exchange apparatus of this embodiment, the design of the housing 700 and the thermal insulation body 600 is also adopted, the thermal insulation body covers the outside of the heat exchange core plate and is connected with the first metal radiant plate 100 in a sealed manner. In this way, the problem that heat exchange between the heat exchange core plate and the external environment affect the heat exchange efficiency can be prevented on the one hand, and the problem that internal dew condensation due to the entry of moisture from the external environment affects heat exchange efficiency can also be avoided on the other hand. The housing is arranged on the outer side of the thermal insulation body and also connected with the first metal radiant plate in a sealed manner. On the one hand, the internal thermal insulation body is protected from being damaged by external forces, and on the other hand, a second seal is achieved. Moreover, the outer surface of the housing is designed as a mirror, which provides the function of a white body and reflects the radiant heat of the external environment. In addition, through the design of the housing and the thermal insulating body, the heat exchange core plate can also be firmly fixed, further keeping the interval between the heat exchange core plate and the first metal radiant plate stable.

In the radiant heat exchange apparatus of this embodiment, the heat transfer coil runs through the thermal insulation body and extends out of the housing. A sealing ring is arranged between the housing and the heat transfer coil to keep the heat exchange core plate off the external environment. Moreover, connectors 501 are also arranged at two ends of the heat transfer coil. The heat transfer coils of multiple radiant heat exchange apparatus can be connected in series and/or in parallel through the connectors 501, and then connected to a cooling/heating medium pipeline of a cooling or heating apparatus.

When the radiant heat exchange apparatus of this embodiment works for cooling, the first metal radiant plate absorbs the external radiant heat, and emits heat to the second metal radiant plate through the reinforcing thermal heat coating film. The reinforcing thermal heat coating film on the surface of the second metal radiant plate absorbs the heat and then transfers the heat to the second metal radiant plate. The heat is then taken away by a cold heat transfer medium in the heat transfer coil fixed on the second metal radiant plate. When the radiant heat exchange apparatus of this embodiment works for heating, a hot heat transfer medium in the copper tube fixed on the second metal radiant plate transfers heat to the second metal radiant plate through conduction, and the relatively high-temperature second metal radiant plate transfers heat to the relatively low-temperature first metal radiant plate through the reinforcing thermal radiation coating film. The reinforcing thermal radiation coating film of the first metal radiant plate absorbs heat and transfers the heat to the first metal radiant plate, and the first metal radiant plate then emits heat to other surfaces in a room to increase the temperature of each surface to achieve an indoor heating effect.

### Second Embodiment

The reinforcing thermal radiation coating that forms the reinforcing thermal radiation coating film described in the first embodiment is prepared from a reinforcing material component, a black material component and a binder. Specifically, the reinforcing thermal radiation coating is prepared from, by mass, 2.5 parts of elemental silicon powder, 2.5 parts of elemental boron powder, 2 parts of carbon black, 2 parts of manganese dioxide, 6 parts of iron oxide black, 30 parts of a styrene/n-butyl acrylate/isopropyl acrylate copolymer, 37 parts of xylene, 12 parts of 1,2-dichloroethane, and 6 parts of n-butyl acetate, wherein the molar ratio of styrene to n-butyl acrylate to isopropyl acrylate is 5:3:1.

In the reinforcing thermal radiation coating of this embodiment, both the powder of the reinforcing material component and the powder of the black material component can be uniformly dispersed in the binder component, and when used, the reinforcing thermal radiation coating can be applied to the surface of a metal material to form a reinforcing thermal radiation coating film. The coating film can greatly improve the thermal radiation ability of the metal material when working together with the metal material. This solution is obtained on the basis of the following facts. Metal materials are called conventional radiation materials in the infrared radiation band, and when silicon or boron is added to a metal plate, the magnetic permeability of the material can be greatly enhanced. It is found through research that when silicon or boron is added to the metal plate, the emissivity and absorptivity of its thermal radiation are also greatly enhanced, and then the material is called a super conventional thermal radiation material. However, adding silicon or boron to the metal material not only requires high cost, but also makes the metal plate very brittle and difficult to process. In addition, when silicon or boron is made into a coating and then applied to a metal plate to form a reinforcing thermal radiation coating film, the radiant heat exchange capability of the metal plate can also be greatly improved. When the reinforcing thermal radiation coating film is formed on the adjacent sides of the first metal radiant plate and the heat exchange core plate, the absorptivity and emissivity between the first metal radiant plate and the heat exchange core plate can be more than 2 times higher than that of conventional thermal radiation materials without the coating film. Moreover, by means of applying a coating to form a coating film, each component can be evenly distributed so that the thermal radiation of the entire coating film is uniform without cold/hot spots, and the coating film can be firmly bonded to a metal material.

The reinforcing thermal radiation coating of this embodiment can greatly improve the radiant heat exchange efficiency when used in a relatively low-temperature environment. However, the existing thermal radiation coating is applied to the inner lining of a relatively high-temperature kiln to reduce the loss of heat, which is fundamentally different from the coating of this embodiment. In the reinforcing thermal radiation coating of this embodiment, the reinforcing material component including silicon and/or boron and the black material component including carbon black and/or manganese dioxide and/or iron oxide black, in cooperation with the surface of a metal material surface, can endow the metal material surface with super conventional emissivity. Moreover, the black material component including carbon black and/or manganese dioxide and/or iron oxide black can also effectively increase the blackness of the surface of the metal material and the surface roughness of the formed coating film and improve the absorption rate and specific surface area for radiant heat exchange. By addition of the binder, the coating film formed by the coating has strong adhesion. Through the combination of the above components, a reinforcing thermal radiation coating film is formed on the surface of the metal material, so that the metal material has super conventionally high absorptivity and emissivity.

The effects of the above-mentioned embodiments are verified below through the following tests.

We designed a test bench for simulating the indoor environment. The test bench was a cube, a cold water radiant plate was arranged at the top side of the inner wall of the cube, and the other five sides of the inner wall were provided with hot water radiant plates which simulated thermally radiant plates, using hot water, on interior walls and floor in an indoor environment.

Test method: The relative humidity of the simulated indoor environment inside the test bench was controlled and maintained at 60%, and then the cold water radiant plate at the top was started and then adjusted to and held at a set temperature of 20° C. The hot water radiant plates on the other five sides were started and then adjusted to and held at 26° C. (simulating the average radiant temperature of a real indoor environment). Relevant parameters, including cold water inlet/outlet temperature, cold water flow, hot water inlet/outlet temperature, hot water flow, heat absorptivity of the cold water radiant plate, and heat emissivity of the hot water radiant plate, were also detected.

The tests were carried out in three groups.
A: In the water cold radiant plate and the hot water radiant plate, neither the surface of the heat exchange core plate nor the surface of the first radiant heat exchange area had a reinforcing thermal radiation coating film. The minimum interval between the heat exchange core plate and the first metal radiant plate was 10 mm.
B: In the water cold radiant plate and the hot water radiant plate, both the surface of the heat exchange core plate and the surface of the first radiant heat exchange area had a reinforcing thermal radiation coating film. The minimum interval between the heat exchange core plate and the first metal radiant plate was 10 mm.
C: In the water cold radiant plate and the hot water radiant plate, both the surface of the heat exchange core plate and the surface of the first radiant heat exchange area had a reinforcing thermal radiation coating film. The minimum interval between the heat exchange core plate and the first metal radiant plate was 2 mm.

The three test groups were tested separately, and Table 1 was obtained.

TABLE 1
Detection data of Tests A, B and C

| | Test A | Test B | Test C |
|---|---|---|---|
| Cold water inlet/outlet temperature | 7/8 | 7/11 | 7/13 |
| (° C.) | | | |
| Cold water flow (L/s) | 0.35 | 0.22 | 0.17 |
| Hot water inlet/outlet temperature | 45/42 | 45/41 | 45/39 |
| (° C.) | | | |
| Hot water flow (L/s) | 0.15 | 0.26 | 0.21 |
| Heat absorptivity of cold water radiant | 1.46 | 3.69 | 4.3 |
| plate (kW) | | | |
| Heat emissivity of hot water radiant | 1.83 | 4.42 | 5.4 |
| plate (kW) | | | |

Through the data obtained in Table 1, comparing Test B with Test A, it can be clearly concluded that the use of the reinforcing thermal radiation coating film can significantly improve the radiant heat exchange efficiency. Comparing Test C with Test B, it can be clearly concluded that the use of a sub-near-field distance of 2 mm can significantly improve the radiant heat exchange efficiency. Comparing Test C with Test A, it can be clearly concluded that the use of the reinforcing thermal radiation coating film and the use of sub-near-field distance can greatly improve the radiant heat exchange efficiency. Moreover, there was no dew condensation on the lower surface of the first metal radiant plate functioning as a cold water radiant plate on the top side in Test C.

The radiant heat exchange apparatus of the above-mentioned embodiments can be used as a heat exchange unit for temperature regulation of indoor or outdoor environments in residential buildings and public buildings, and can be specifically designed as wall panels, ceilings, etc. The radiant heat exchange apparatus also can be used as a heat exchange apparatus for communication base stations, server equipment and equipment rooms. Certainly, the radiant heat exchange apparatus can also be used in other relatively low-temperature heat exchange occasions.

The above embodiments shall not limit the invention in any way, and all technical solutions obtained by means of equivalent replacement or equivalent transformation fall within the scope of the invention.

1. A reinforcing thermal radiation coating, comprising, by mass: 4-6 parts of a reinforcing material component, 6-13 parts of a black material component, and 81-90 parts of a binder, wherein the reinforcing material component is silicon or boron or a mixture of silicon and boron in any proportion.

2. The reinforcing thermal radiation coating according to claim 1, wherein the black material component is one of iron oxide black, carbon black and manganese dioxide or a mixture of several thereof in any proportion.

3. The reinforcing thermal radiation coating according to claim 2, wherein the binder comprises, by mass, 50-60 parts of a solvent and 20-40 parts of a binder component; the solvent is one of xylene, trimethylbenzene, tetramethylbenzene, 1,2-dichloroethane, and n-butyl acetate or a mixture of several thereof in any proportion; the binder component is a copolymer of styrene, n-butyl acrylate and isopropyl acrylate and a molar ratio of styrene to n-butyl acrylate to isopropyl acrylate is (4-6):(2-4):1.

4. The reinforcing thermal radiation coating according to claim 3, wherein the reinforcing thermal radiation coating is prepared from, by mass, 2.5 parts of elemental silicon powder, 2.5 parts of elemental boron powder, 2 parts of carbon black, 2 parts of manganese dioxide, 6 parts of iron oxide black, 30 parts of a styrene/n-butyl acrylate/isopropyl acrylate copolymer, 37 parts of xylene, 12 parts of 1,2-dichloroethane, and 6 parts of n-butyl acetate, wherein the molar ratio of styrene to n-butyl acrylate to isopropyl acrylate is 5:3:1.

5. An application of the reinforcing thermal radiation coating according to claim 1, wherein the reinforcing thermal radiation coating is applied to a surface of a metal material to form a reinforcing thermal radiation coating film.

6. A radiant heat exchange apparatus using the reinforcing thermal radiation coating film according to claim 5, comprising a first metal radiant plate, a second metal radiant plate, and a heat transfer channel, wherein the second metal radiant plate is in contact with the heat transfer channel and forms a heat exchange core plate together the heat transfer channel; the first metal radiant plate is provided with a first radiant heat exchange area on a side close to the heat exchange core plate, the heat exchange core plate corresponds to the first radiant heat exchange area of the first metal radiant plate and is placed in parallel to and spaced from the first radiant heat exchange area of the first metal radiant plate with an interval, the minimum interval between the heat exchange core plate and the first metal radiant plate is defined as 1-3 mm, and the reinforcing thermal radiation coating film is formed on a side surface of the heat exchange core plate close to the first metal radian plate and on a surface of the first radiant heat exchange area.

7. The radiant heat exchange apparatus according to claim 6, wherein the interval is formed by an isolation net arranged between the heat exchange core plate and the first metal radiant plate, a skeleton of the isolation net is configured to provide isolation and support functions, mesh holes of the isolation net are configured to provide space for radiant heat exchange, and the isolation net has a thickness of 1-3 mm to ensure that the minimum interval between the heat exchange core plate and the first metal radian plate is within a range of 1-3 mm.

8. The radiant heat exchange apparatus according to claim 7, wherein the isolation net has a thickness of 2 mm to ensure that the minimum interval between the heat exchange core plate and the first metal radian plate is 2 mm.

9. The radiant heat exchange apparatus according to claim 7, wherein the heat transfer channel is configured as a heat transfer coil provided with a heat transfer medium therein; a first groove corresponding to the heat transfer coil is pressed on the second metal radiant plate, the heat transfer coil is placed in the first groove of the second metal radiant plate, the first groove of the second metal radiant plate is also correspondingly provided with a bead, the bead also has a second groove corresponding to the first groove, the first groove and the second groove jointly form an accommodating channel for the heat transfer coil, the bead is also configured to make an outer wall of the heat transfer coil closely adhere to an inner wall of the groove of the second metal radiant plate.

10. The radiant heat exchange apparatus according to claim 6, further comprising a housing, wherein the housing and the first metal radiant plate form a closed cavity and the heat exchange core plate is arranged in the cavity; a thermal insulation body is arranged in the housing, and the thermal insulation body is bonded to the first metal radiant plate to form an insulating sealed cavity, which is used to prevent internal dew condensation caused by moisture entering an empty cavity between the heat exchange core plate and the first metal radiant plate and which is also used to isolate heat transfer between the housing and the heat exchange core plate; the housing is configured to reflect the energy of external thermal radiation through an outer surface thereof, and can protect the thermal insulation body from damage by an external force; two ends of the heat transfer coil respectively pass through the thermal insulation body and the housing and are exposed outside the radiant heat exchange apparatus; the housing is provided with a through hole at the position where the heat transfer coil runs out of the radiant heat exchange apparatus; a sealing ring fitted over the heat transfer coil is also arranged in the through hole.

11. The radiant heat exchange apparatus according to claim 7, further comprising a housing, wherein the housing and the first metal radiant plate form a closed cavity and the heat exchange core plate is arranged in the cavity; a thermal insulation body is arranged in the housing, and the thermal insulation body is bonded to the first metal radiant plate to form an insulating sealed cavity, which is used to prevent internal dew condensation caused by moisture entering an empty cavity between the heat exchange core plate and the first metal radiant plate and which is also used to isolate heat transfer between the housing and the heat exchange core plate; the housing is configured to reflect the energy of external thermal radiation through an outer surface thereof, and can protect the thermal insulation body from damage by an external force; two ends of the heat transfer coil respectively pass through the thermal insulation body and the housing and are exposed outside the radiant heat exchange apparatus; the housing is provided with a through hole at the position where the heat transfer coil runs out of the radiant heat exchange apparatus; a sealing ring fitted over the heat transfer coil is also arranged in the through hole.

12. The radiant heat exchange apparatus according to claim 8, further comprising a housing, wherein the housing and the first metal radiant plate form a closed cavity and the heat exchange core plate is arranged in the cavity; a thermal insulation body is arranged in the housing, and the thermal insulation body is bonded to the first metal radiant plate to form an insulating sealed cavity, which is used to prevent internal dew condensation caused by moisture entering an empty cavity between the heat exchange core plate and the first metal radiant plate and which is also used to isolate heat transfer between the housing and the heat exchange core plate; the housing is configured to reflect the energy of external thermal radiation through an outer surface thereof, and can protect the thermal insulation body from damage by an external force; two ends of the heat transfer coil respectively pass through the thermal insulation body and the housing and are exposed outside the radiant heat exchange apparatus; the housing is provided with a through hole at the position where the heat transfer coil runs out of the radiant heat exchange apparatus; a sealing ring fitted over the heat transfer coil is also arranged in the through hole.

13. The radiant heat exchange apparatus according to claim 9, further comprising a housing, wherein the housing and the first metal radiant plate form a closed cavity and the heat exchange core plate is arranged in the cavity; a thermal insulation body is arranged in the housing, and the thermal insulation body is bonded to the first metal radiant plate to form an insulating sealed cavity, which is used to prevent internal dew condensation caused by moisture entering an empty cavity between the heat exchange core plate and the first metal radiant plate and which is also used to isolate heat transfer between the housing and the heat exchange core plate; the housing is configured to reflect the energy of external thermal radiation through an outer surface thereof, and can protect the thermal insulation body from damage by an external force; two ends of the heat transfer coil respectively pass through the thermal insulation body and the housing and are exposed outside the radiant heat exchange apparatus; the housing is provided with a through hole at the position where the heat transfer coil runs out of the radiant heat exchange apparatus; a sealing ring fitted over the heat transfer coil is also arranged in the through hole.

14. An application of the reinforcing thermal radiation coating according to claim 4, wherein the reinforcing thermal radiation coating is applied to a surface of a metal material to form a reinforcing thermal radiation coating film.

15. A radiant heat exchange apparatus using the reinforcing thermal radiation coating film according to claim 14, comprising a first metal radiant plate, a second metal radiant plate, and a heat transfer channel, wherein the second metal radiant plate is in contact with the heat transfer channel and forms a heat exchange core plate together the heat transfer channel; the first metal radiant plate is provided with a first radiant heat exchange area on a side close to the heat exchange core plate, the heat exchange core plate corresponds to the first radiant heat exchange area of the first metal radiant plate and is placed in parallel to and spaced from the first radiant heat exchange area of the first metal radiant plate with an interval, the minimum interval between the heat exchange core plate and the first metal radiant plate is defined as 1-3 mm, and the reinforcing thermal radiation coating film is formed on a side surface of the heat exchange core plate close to the first metal radian plate and on a surface of the first radiant heat exchange area.

16. The radiant heat exchange apparatus according to claim 15, wherein the interval is formed by an isolation net arranged between the heat exchange core plate and the first metal radiant plate, a skeleton of the isolation net is configured to provide isolation and support functions, mesh holes of the isolation net are configured to provide space for radiant heat exchange, and the isolation net has a thickness of 1-3 mm to ensure that the minimum interval between the heat exchange core plate and the first metal radian plate is within a range of 1-3 mm.

17. The radiant heat exchange apparatus according to claim 16, wherein the isolation net has a thickness of 2 mm to ensure that the minimum interval between the heat exchange core plate and the first metal radian plate is 2 mm.

18. The radiant heat exchange apparatus according to claim 16, wherein the heat transfer channel is configured as a heat transfer coil provided with a heat transfer medium therein; a first groove corresponding to the heat transfer coil is pressed on the second metal radiant plate, the heat transfer coil is placed in the first groove of the second metal radiant plate, the first groove of the second metal radiant plate is also correspondingly provided with a bead, the bead also has a second groove corresponding to the first groove, the first groove and the second groove jointly form an accommodating channel for the heat transfer coil, the bead is also configured to make an outer wall of the heat transfer coil closely adhere to an inner wall of the groove of the second metal radiant plate.

19. The radiant heat exchange apparatus according to claim 16, further comprising a housing, wherein the housing and the first metal radiant plate form a closed cavity and the heat exchange core plate is arranged in the cavity; a thermal insulation body is arranged in the housing, and the thermal insulation body is bonded to the first metal radiant plate to form an insulating sealed cavity, which is used to prevent internal dew condensation caused by moisture entering an empty cavity between the heat exchange core plate and the first metal radiant plate and which is also used to isolate heat transfer between the housing and the heat exchange core plate; the housing is configured to reflect the energy of external thermal radiation through an outer surface thereof, and can protect the thermal insulation body from damage by an external force; two ends of the heat transfer coil respectively pass through the thermal insulation body and the housing and are exposed outside the radiant heat exchange apparatus; the housing is provided with a through hole at the position where the heat transfer coil runs out of the radiant heat exchange apparatus; a sealing ring fitted over the heat transfer coil is also arranged in the through hole.

20. The radiant heat exchange apparatus according to claim 18, further comprising a housing, wherein the housing and the first metal radiant plate form a closed cavity and the heat exchange core plate is arranged in the cavity; a thermal insulation body is arranged in the housing, and the thermal insulation body is bonded to the first metal radiant plate to form an insulating sealed cavity, which is used to prevent internal dew condensation caused by moisture entering an empty cavity between the heat exchange core plate and the first metal radiant plate and which is also used to isolate heat transfer between the housing and the heat exchange core plate; the housing is configured to reflect the energy of external thermal radiation through an outer surface thereof, and can protect the thermal insulation body from damage by an external force; two ends of the heat transfer coil respectively pass through the thermal insulation body and the housing and are exposed outside the radiant heat exchange apparatus; the housing is provided with a through hole at the position where the heat transfer coil runs out of the radiant heat exchange apparatus; a sealing ring fitted over the heat transfer coil is also arranged in the through hole.
